(19) United States
(12) Patent Application Publication
(10) Pub. No.: US 2009/0311507 A1
(43) Pub. Date: Dec. 17, 2009

(54) THERMAL INSULATION MATERIAL

(75) Inventors: Peter Bauer, Munchen (DE); Erich Hell, Giengen (DE); Peter Nalbach, Kirchheim/Nabern (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 12/225,948

(22) PCT Filed: Mar. 14, 2007
(86) PCT No.: PCT/EP2007/052407

§ 371 Date: Jun. 29, 2009

(30) Foreign Application Priority Data
Apr. 5, 2006 (DE) 10 2006 015 993.4

(51) Int. Cl. B32B 5/16; C08K 3/04

(52) U.S. Cl. 428/304.4; 524/589

(57) ABSTRACT

A thermal insulation material comprising a porous substrate made of a synthetic resin composition to which particles are applied that essentially have the shape of small plates. The average diameter of the particles can range from 0.1 times to 10 times the average diameter of the pores.

The present invention relates to a thermal insulation material and applications therefor.

Polyurethane foam is generally used as the insulation material in the housings of modern household refrigeration appliances. Foamed with Pentane, the thermoconducting capability of this foam reaches values of down to below 20 mW/K/m. The thermoconducting capacity is the result of three thermal transport mechanisms, thermal conductance through solid component of the foam, i.e. the polyurethane itself, thermal conductance through the gases which fill out the pores of the foam, and thermal radiation. Possible ways of minimizing the amount of thermal radiation are to reduce the size of the pores or to increase the radiation absorption or reflection through the pore walls.

A possible approach to optimization is to optimize the chemical composition of the synthetic resin to be foamed in order to reduce the pore size of the resulting foam. A second approach is to apply carbon particles to the synthetic resin. Because of its high absorption capability, the carbon reduces the contribution of the thermal radiation to the overall thermal conducting capability, on the other hand it increases the thermal conductance of the synthetic resin material, the thermal conductance capability of which increases by the addition of the carbon.

The object of the invention is to create a thermal insulation material with a porous substrate made from a synthetic resin composition to which particles are applied, in which the particles effectively restrict the thermal transport by radiation, without simultaneously significantly increasing the flow of heat through the solid component of the substrate, and to do so even if the particles consist of a material which has better thermoconductive capabilities than the synthetic resin composition into which they are embedded.

The object is inventively achieved by the particles essentially having the shape of small plates.

In the polyurethane foams currently widely used as thermally-insulating porous substrates, around 90% of the solid material is concentrated in rods, i.e. in elongated structures extending between three adjacent gas bubbles. Only appr. 10% of the solid is located in walls between two adjacent bubbles. If it is assumed that added particles are distributed homogeneously in the solid component of the foam, then as a consequence they are concentrated up to 90% in the rod, where they have only little influence on the thermal radiation, but make a significant contribution to thermal conductance through the solid. Actually however surface tension effects lead to the particles accumulating in the rods during foaming whereas there is a paucity of particles in the walls.

The approach of the invention lies in using a flat shape of particle to give these better insertion into the walls of the substrate and thus reduce their tendency to accumulate in the rods.

In addition a sufficient size of particle can be used to ensure that these do not simply fit into the rods. Thus a tendency of the particles to accumulate in the walls rather than a tendency to accumulate in the rods is achieved. For this the average diameter of the particles is preferably between 0.1 times and 10 times the average diameter of the pores. If the diameter is less than 0.1 times the diameter of the pore, the particles fit into the rods too well to bring about an accumulation in the walls. With a diameter of more than 10 times the average pore diameter the viscosity of a flowable synthetic resin compound from which the inventive thermal insulation material is obtained by foaming can be increased, which adversely affects the workability of the flowable composition.

Ideally the average diameter of the particle is approximately equivalent to the average diameter of the pores.

With a typical pore diameter of conventional insulation foams of appr. 100 to 500 micrometers a value between 10 and 1000 micrometers can be specified as the preferred average diameter of the particles.

The optimum thickness of the particles is defined by two effects. To keep the thermal conductivity of the substrate low, the thickness of the particles should also be small, expediently not more than five times the thickness of the rods, even better not more than the single thickness of the rods. The thickness of the rods can vary between 1 and 50 micrometers depending on the composition of the synthetic resin, so that a preferred thickness of not more than 10 to 50 micrometers is produced for the particles.

The particles can prevent thermal transport via radiation through absorption or through reflection. If the particles are made of a material which absorbs thermal radiation, their thickness, in order to achieve an efficient absorption, should roughly correspond to the absorption length of the thermal radiation in the material of the particles, i.e. that length on which the intensity of the thermal radiation propagating through the material of the particles reduces to 1/e. In the case of a material which is essentially acts by reflection, the thickness of the particles should be as small as possible.

The object of the invention is also a flowable synthetic resin composite to which particles of an essentially plate shape are applied and which is able to be foamed into a thermal insulation material as described above.

An exemplary embodiment of such a flowable synthetic resin composition can be a composition based on polyurethane resin which is occupied by plate-shaped graphitic material. The graphitic material can be a commercially-available natural or synthetic flake graphite, but carbon blacks or graphites are also considered which are embedded for better resilience of the particle shape into a synthetic resin matrix. The thermal insulation material is obtainable from a particle-treated synthetic resin composition by foaming with a propellant gas in a manner known to the person skilled in the art.

The foaming can be undertaken in conjunction with the injection of the synthetic resin composition into a cavity, which is filled after the injection by the expanding synthetic resin. Such a cavity can especially be a housing for a household appliance which is initially constructed with hollow walls, and for which the particle-treated resin composition is subsequently injected into the cavities of the walls and is left to expand and harden there.

1-11. (canceled)

12. A thermal insulation material comprising:
a porous substrate made from a synthetic resin composition to which particles were applied, the particles that were applied having been substantially in the shape of small plate-like configurations in which a thickness dimension is several orders of magnitude less than a width dimension.

13. The thermal insulation material as claimed in claim 12, wherein the particles have an average diameter which is between 0.1 times and 10 times the average diameter of pores of the porous substrate.

14. The thermal insulation material as claimed in claim 12, wherein the average diameter of the particles is between 0.5 times and 2 times the average diameter of pores of the porous substrate.

15. The thermal insulation material as claimed in claim 12, wherein the average diameter of the particles amounts to between 10 and 1000 μm.

16. The thermal insulation material as claimed in claim 12, wherein the average thickness of the particles amounts to not more than five times the thickness of rods of the porous substrate.

17. The thermal insulation material as claimed in claim 16, wherein the average thickness of the particles amounts to not more than the thickness of rods of the porous substrate.

18. The thermal insulation material as claimed in claim 12, wherein the particles consist of thermal radiation-absorbing material and the average thickness of the particles corresponds to the absorption length of the thermal radiation in the material of the particles.

19. The thermal insulation material as claimed in claim 12, wherein the particles contain graphitic carbon.

20. A housing for a household appliance, comprising:
a body portion; and
at least one thermally-insulating wall featuring a thermal insulation material formed of a porous substrate made from a synthetic resin composition to which particles were applied, the particles that were applied having been substantially in the shape of small plate-like configurations in which a thickness dimension is several orders of magnitude less than a width dimension.

21. A synthetic flowable resin comprising:
a base material; and
particles in the base material that are substantially in the shape of small plate-like configurations in which a thickness dimension is several orders of magnitude less than a width dimension, the synthetic flowable resin being useable to form a synthetic resin composition.
